(19) United States
(12) Patent Application Publication
(10) Pub. No.: US 2009/0064927 A1
(43) Pub. Date: Mar. 12, 2009

(54) SINGLE SIDED TREATMENT METHOD AND HOLLOW HOLDING APPARATUS

(76) Inventor: Ming-Yuan Wu, Taipei City (TW)

Correspondence Address: SINORICA, LLC, 528 FALLSGROVE DRIVE, ROCKVILLE, MD, 20850, US

(21) Appl. No.: 11/850,703

(22) Filed: Sep. 6, 2007

(51) Int. Cl. B05C 3/20

(52) U.S. Cl. 118/428; 118/500

(57) ABSTRACT

A method for applying treatment to a single side or surface of an object while preventing other surfaces from being treated and a holder used during the treatment process are disclosed. An object is placed in an opening of the holder. The holder firmly holds the object during the treatment process. The holder comprises a hollow interior so that when the object and holder are dipped into the solution in the tank, air is trapped inside the holder. Air pressure prevents the solution from entering into the hollow interior portion of the holder. In this way, the treatment solution is only applied to the exposed surface of the object and not to the surface in the interior of the holder.

### BACKGROUND OF THE INVENTION

1. Field of the Invention

The present invention relates to treatment methods. More specifically, the present invention discloses a method for applying treatment to a single side or surface of an object while preventing other surfaces of the object from being treated and a hollow holding apparatus used during the treating process.

2. Description of the Prior Art

Plastic material has increasingly become one of the most popular materials used to produce various products. Some of the numerous advantages of plastic are low cost, light weight, and high formability. However, there are several disadvantages to using plastic, for example, plastic is easily broken, scratched, or deformed.

In order to overcome some of the disadvantages, plastic objects are commonly treated to improve certain characteristics or to protect the object. Conventional treatments include hardness treatment, coating, and plating. Typically, a hardness treatment is performed by dipping the plastic object into a tank containing a treatment solution. During the dipping the treatment solution coats all surfaces of the plastic object. After drying the surfaces of the plastic object have a higher level of protection against scratches or abrasion.

However, successful coating of plastic objects is often difficult to achieve due to the low adhesion factor of plastic surfaces.

There are many instances where it is not desired to have all surfaces treated. In these situations it would be preferable to selectively choose which surfaces are to be treated. Unfortunately, conventional treatment processing methods cannot provide this option.

Also, since grooves, notches, or non-flat areas on the surfaces will cause the solution to run or dry unevenly, they are created on the surface after the hardness treatment. However, since the surfaces have increased in hardness the hardness solution must be removed or the surface must be machined by CNC machining. This process causes defects on the edges of the surface and is expensive and slow.

Therefore, there is need for an improved method of treating one side or surface of an object while preventing treatment from being applied to other surfaces.

### SUMMARY OF THE INVENTION

To achieve these and other advantages and in order to overcome the disadvantages of the conventional method in accordance with the purpose of the invention as embodied and broadly described herein, the present invention provides a treatment process method for applying treatment to a single side of an object and a hollow holder for use during the treatment process.

An objective of the present invention is to provide an effective method of applying a treatment solution to a desired surface of an object and preventing application of the treatment solution to surfaces where the solution isn't desired.

The single sided treatment method of the present invention comprises placing an object into a holder. The holder firmly holds the object during the treatment process. The holder is hollow so when the object and holder are dipped into the solution in the tank air is trapped inside the holder. Air pressure prevents the solution from entering into the hollow interior portion of the holder. In this way, the treatment solution is only applied to the exposed surface of the object and not to the surface in the interior of the holder.

After the solution has dried only one side or surface of the object has increased in hardness. The untreated side can now be easily machined to create grooves, notches, designs, logos, indentations, or other patterns.

An object of the present invention is to provide a simple and effective method for treating one surface of an object and preventing treatment to other surfaces of the object. An object is inserted into a holder. The holder comprises an opening of a suitable shape for holding the object during the treatment process. Once the object is placed in the holder the opening is filled by the object and wall is formed in the holder. As a result, a hollow interior is formed in the holder.

The holder is lowered into a tank containing a treatment solution. When the holder contacts the treatment solution air is trapped in the hollow interior of the holder. The air and air pressure prevent treatment solution from entering the interior of the holder and the surface of the object in the interior of the holder is prevented from being exposed to the treatment solution. As the treatment solution comes into contact with the surface of the object on the exterior of the holder the exposed surface is treated. As a result, the method of the present invention provides an efficient means of treating a single surface of an object and prevents other surfaces from being treated.

The present invention also provides for a method for treating a single surface of an object where the object is formed by molding the object and holder in the same piece. The object with holder comprises a hollow interior. When dipped into treatment solution air trapped in the hollow interior prevents the treatment solution from entering into the hollow interior. After the object with holder is removed from the treatment solution and the treatment solution is allowed to dry, the holder and the object are separated.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIGS. 1A-1F are drawings illustrating holders utilized in a treatment process according to embodiments of the present invention;

FIG. 2 is a flowchart illustrating a method for treating a single surface of an object according to an embodiment of the present invention;

FIG. 3A is a flowchart illustrating a method for treating a single surface of an object according to an embodiment of the present invention;

FIG. 3B is a flowchart illustrating a method for treating a single surface of an object according to an embodiment of the present invention;

FIG. 4 is a flowchart illustrating a method for treating a single surface of an object according to an embodiment of the present invention;

FIG. 5A is a drawing illustrating two objects and an ultrasonic mold prior to treatment according to an embodiment of the present invention;

FIG. 5B is a drawing illustrating assembly of two objects using an ultrasonic mold according to an embodiment of the present invention;

FIG. 5C is a drawing illustrating the assembled two objects using an ultrasonic mold according to an embodiment of the present invention;

FIG. 5D is a drawing illustrating a treatment process on the assembled two objects according to an embodiment of the present invention;

FIG. 5E is a drawing illustrating the assembled two objects after treatment according to an embodiment of the present invention; and

FIG. 5F is a drawing illustrating the two objects after disassembly according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

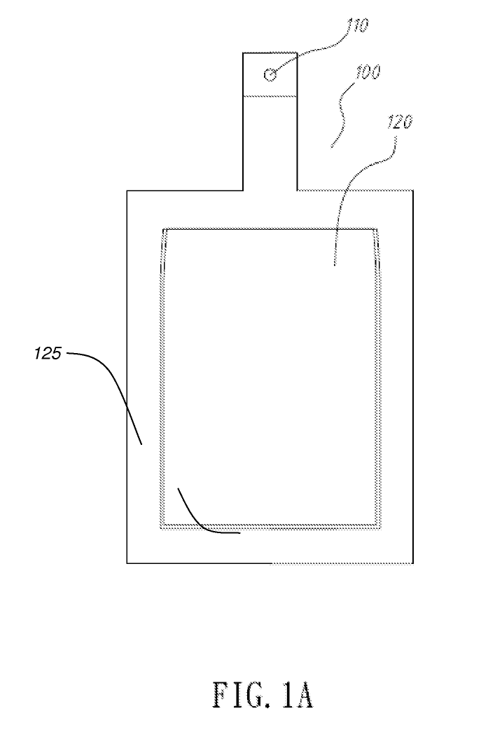

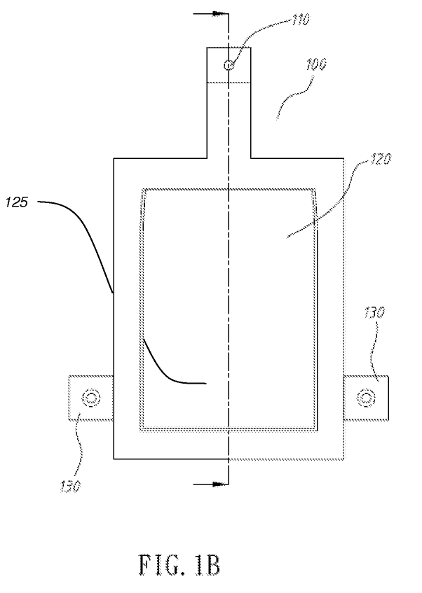

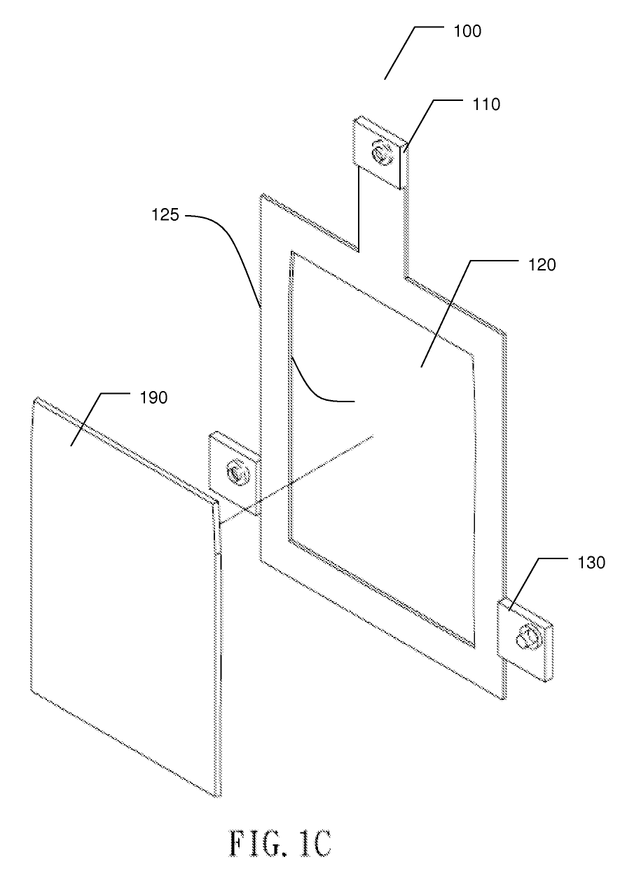

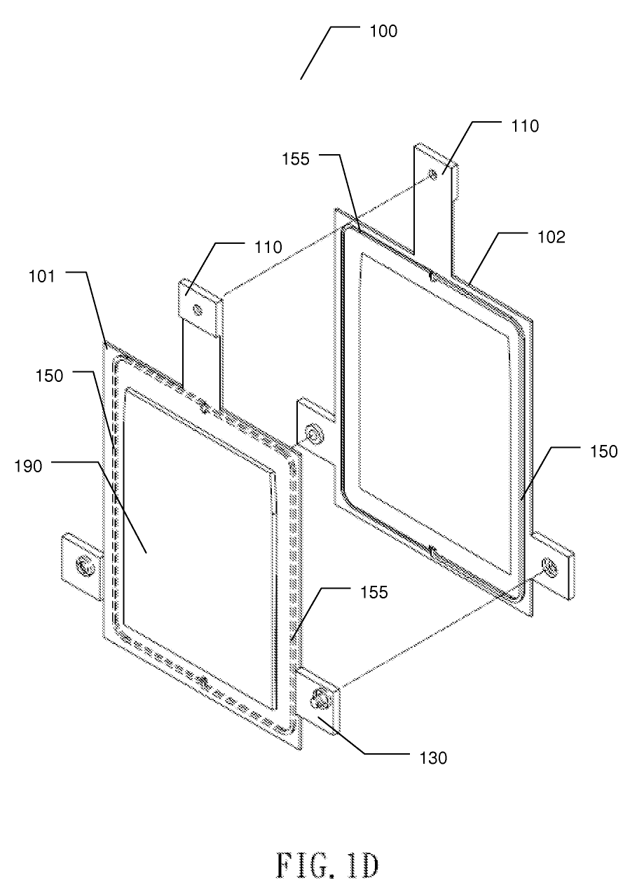

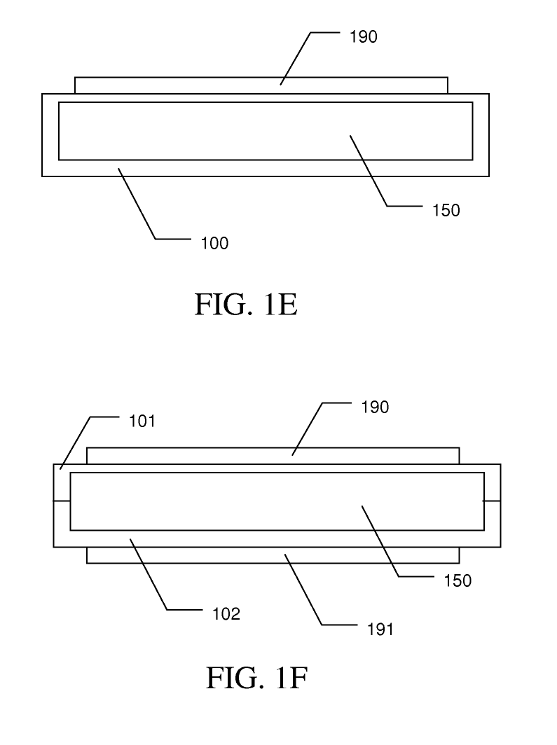

Refer to FIGS. 1A-1C and FIG. 1E, which are drawings illustrating a holder utilized in a treatment process according to an embodiment of the present invention. FIGS. 1A and 1B illustrate front views of the holder, FIG. 1C illustrates an exploded view of the holder and the object, and FIG. 1E illustrates a bottom view of the holder and object.

As shown in FIGS. 1A-1C and FIG. 1E, the holder 100 comprises a grip 110 for attaching the holder 100 to a processing arm used when dipping the holder into a tank holding treatment solution. In this embodiment the holder 100 is formed or molded in a single piece. An opening 120 in the holder 100 allows an object 190 to be placed in the opening 120 and held by the holder 100. The sides of the opening are shaped to conform to the shape of the object 190 allowing the object 190 to be held by the holder 100. Once the object 190 is in the holder 100 the opening 120 is filled creating a wall in the holder 100. Since the back 125 of the holder 100 is already solid, a hollow interior 160 is formed in the holder 100.

In use an object 190 is placed in the opening and firmly held by the holder 100. The grip 110 is then attached to the processing arm and the holder 100 and object 190 are lowered into the treatment solution. Air is trapped in the hollow interior 160 of the holder 100 and air pressure prevents the treatment solution from entering the interior 160 of the holder. As a result, the treatment solution is only applied to the exposed exterior surface of the object 190. After treating the holder 100 is removed from the solution and the solution is allowed to dry. When dry the object 190 is removed from the holder 100 and can now be machined to create grooves, notches, designs, logos, indentations, or other patterns in the untreated surface of the object 190.

In the embodiment illustrated in FIGS. 1A-1C and FIG. 1E, the holder is designed for holding a thin piece of plastic. However, in other embodiments of the present invention the holder is designed for holding different objects. The opening or openings in the holder are shaped depending on the object or the shape of the object to be treated.

Refer to FIGS. 1D and 1F, which are drawings illustrating a holder utilized in a treatment process according to an embodiment of the present invention. FIG. 1D illustrates an exploded view of a two piece holder and FIG. 1F illustrates a bottom view of the two piece holder and objects.

As shown in FIGS. 1D and 1F, the holder 100 in this embodiment comprises a two piece holder. The two piece holder 100 comprises a first piece 101 and a second piece 102. Both pieces 101 102 comprise an opening 120 in which an object 190 is placed and held by the holder 100. In this way, the holder 100 holds two objects 190 during the treatment process and productivity is doubled. The first piece 101 and the second piece 102 comprise mating elements 150 155, for example, slots and tabs or indentations and protrusions that allow the two pieces 101 102 to attach together. Each piece 101 102 further comprises a tab 130 for CNC positioning. In an embodiment of the present invention the tabs 130 are different sizes or in different locations allowing the two pieces 101 102 of the holder 100 to be easily separated. For example, the tabs are offset by 30 percent and grasping the tab on piece 101 and piece 102 the two pieces can be pulled apart.

In use, an object 190 is placed in the opening of the first piece 101 and another object 191 is placed in the opening of the second piece 102. Next, the first piece 101 and second piece 102 are attached together. Once the objects 190 191 are positioned and the two pieces 101 102 are attached together a hollow interior 150 is created in the holder 100. The holder 100 is then placed in a tank containing a treatment solution. Air is trapped in the hollow interior 150 when the holder 100 is lowered into the treatment solution and air pressure prevents the solution from entering the interior 150 of the holder 100. As a result, only the exposed surfaces or sides of the objects 190 191 are treated and leaving the surfaces on the interior 150 of the holder 100 untreated. In this way, the holder 100 of the present invention provides an efficient and effective means of treating a single side of an object.

In an embodiment of the present invention the two pieces are identical formed from the same mold design. In order for the mating elements to function correctly, the pattern of the mating elements is divided into two opposing sections. For example, a protruding ridge is formed on the right side of the holder piece and an indented groove is formed on the left side of the holder piece. For clarity a clock face example is given with the protrusion being formed from 1 o'clock to 4 o'clock and the indentation being formed from 8 o'clock to 11 o'clock. Obviously other patterns can be selected allowing the identical pieces to attach together.

In other embodiments the two pieces are formed from different molds or mold designs. This allows for more flexibility in selecting mating elements.

In an embodiment of the present invention the openings in the holder are different allowing two different types of objects to be treated at the same time.

It should be noted that the number of openings is selectable. For example, the holder can have 1, 2, 4, 8, 16, or other number of openings. This allows the level of production to be controlled.

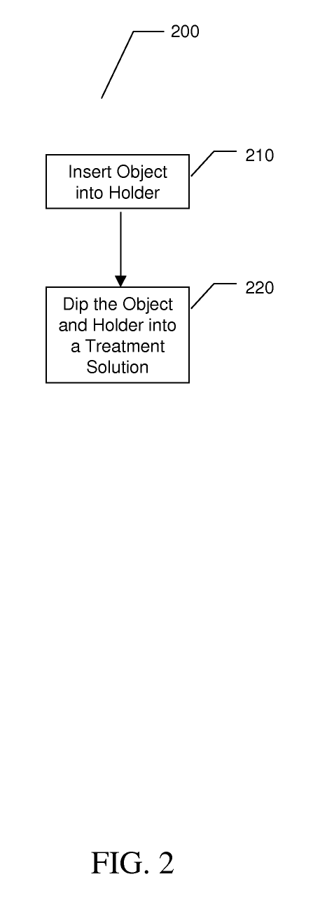

Refer to FIG. 2, which is a flowchart illustrating a method for treating a single surface of an object according to an embodiment of the present invention.

The method 200 of the present invention begins by inserting an object into a holder in Step 210. The holder comprises an opening of a suitable shape for holding the object during the treatment process. Once the object is placed in the holder the opening is filled by the object and wall is formed in the holder. As a result, a hollow interior is formed in the holder.

In Step 220 the holder is lowered into a tank containing a treatment solution. When the holder contacts the treatment solution air is trapped in the hollow interior of the holder. The air and air pressure prevent treatment solution from entering the interior of the holder and the surface of the object in the interior of the holder is prevented from being exposed to the treatment solution. As the treatment solution comes into contact with the surface of the object on the exterior of the holder the exposed surface is treated. As a result, the method of the present invention provides an efficient means of treating a single surface of an object and prevents other surfaces from being treated.

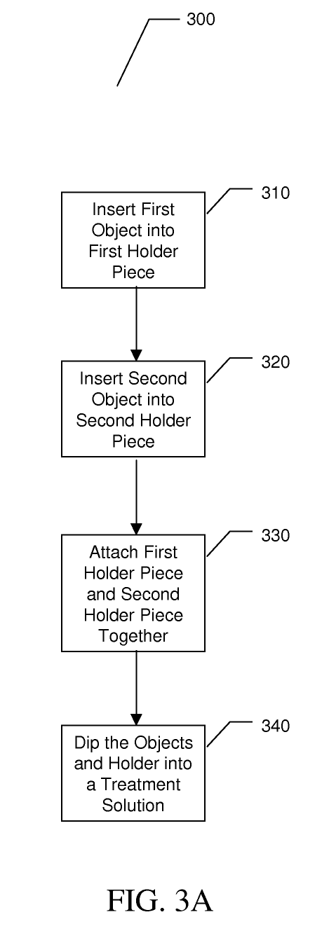

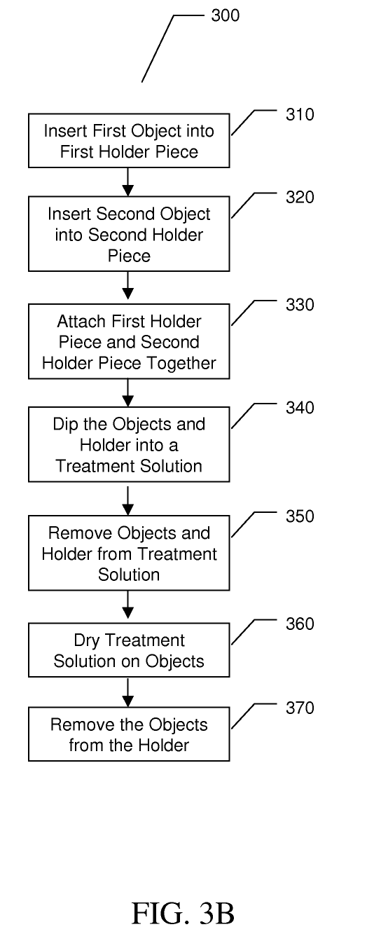

Refer to FIG. 3A, which is a flowchart illustrating a method for treating a single surface of an object according to an embodiment of the present invention.

As shown in FIG. 3, the method 300 begins by placing a first object into an opening in a first holder piece in Step 310. In Step 320 a second object is placed into an opening in a second holder piece. Next, in Step 330 the first holder piece and the second holder piece are attached together to form a holder. In Step 340 the holder is dipped into a treatment solution. Similar to the method of FIG. 2, air is trapped inside the holder thereby preventing treatment solution from entering the holder and only the exposed surfaces of the objects are treated.

Refer to FIG. 3B, which is a flowchart illustrating a method for treating a single surface of an object according to an embodiment of the present invention.

The embodiment illustrated in FIG. 3B is similar to the embodiment of FIG. 3A but further comprises removing the holder from the treatment solution in Step 350. In Step 360 the treatment solution on the exposed surfaces of the objects is allowed to dry. The objects are then removed from the holder in Step 370. The untreated surfaces of the objects are then machined to create grooves, notches, designs, logos, indentations, or patterns on the untreated surfaces.

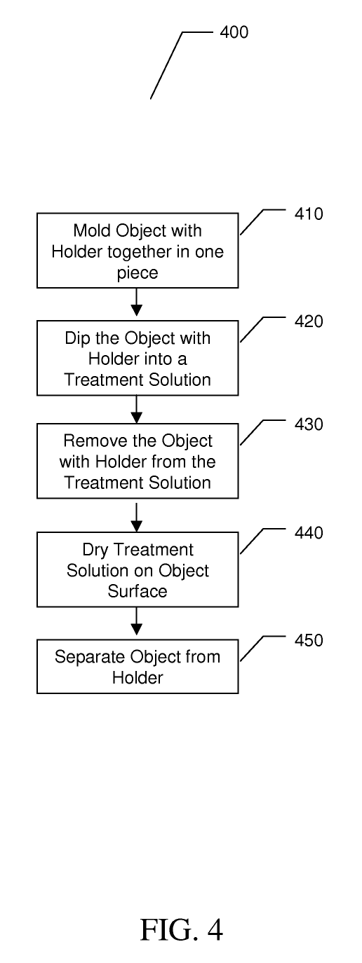

Refer to FIG. 4, which is a method for treating a single surface of an object according to an embodiment of the present invention.

In the method 400 illustrated in FIG. 4, the object is formed, for example, by molding the object and holder in the same piece in Step 410. This method eliminates the steps of inserting the object into a holder and attaching the two pieces of the holder together. The object with holder comprises a hollow interior. In Step 420 the object with holder is dipped into a treatment solution. Similar to other embodiments air trapped in the hollow interior prevents the treatment solution from entering into the hollow interior. After the object with holder is removed from the treatment solution in Step 430 the treatment solution is allowed to dry in Step 440. Then the holder and the object are separated, for example, by CNC machining in Step 450. The holder is discarded or the material is recycled.

In another embodiment of the present invention the holder of the object forms one half of a holder. The holders of two objects are attached together to form one two-piece holder with two or more objects prior to treatment. This allows for two or more objects to be treated at the same time. After treatment the holders and objects are separated.

In an embodiment of the present invention two objects are attached together, for example, by adhesive or film in order to keep the objects together during machining.

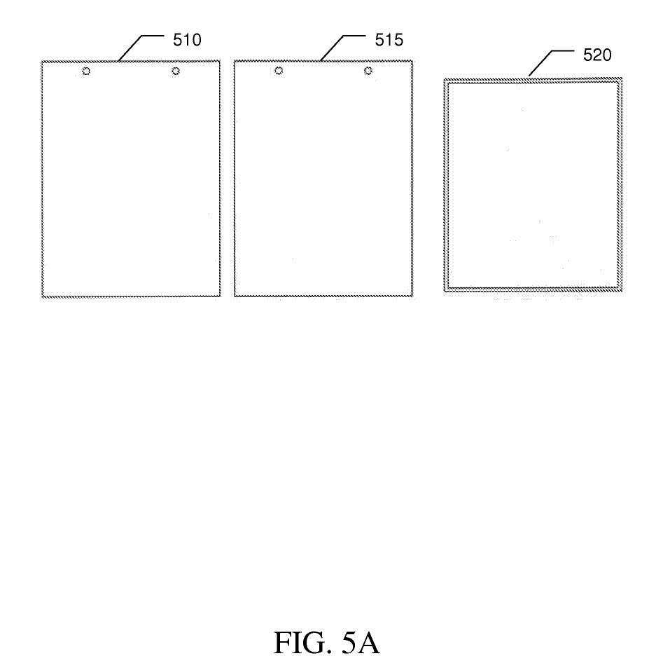

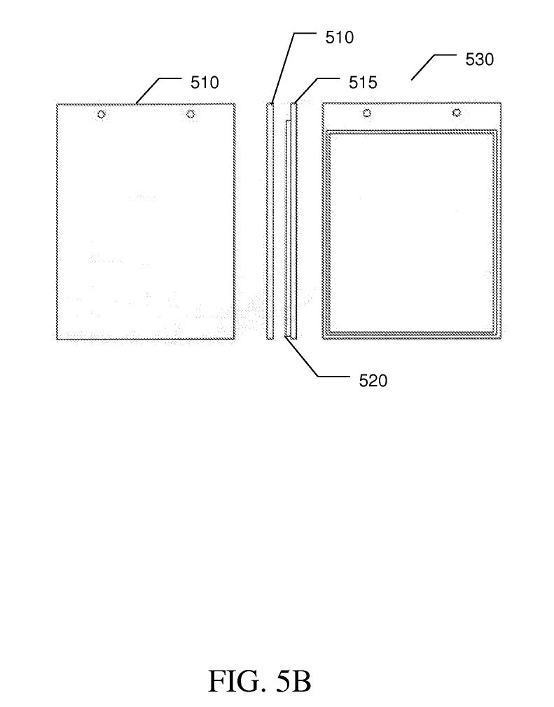

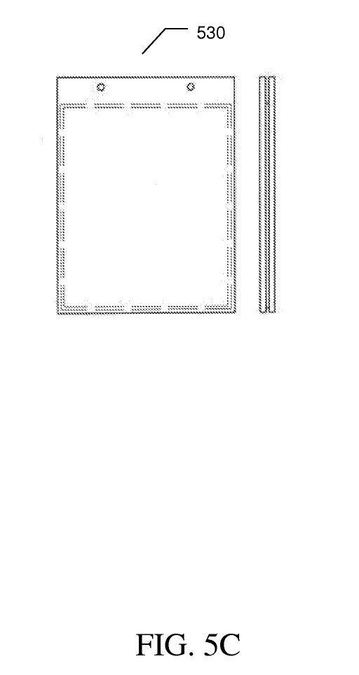

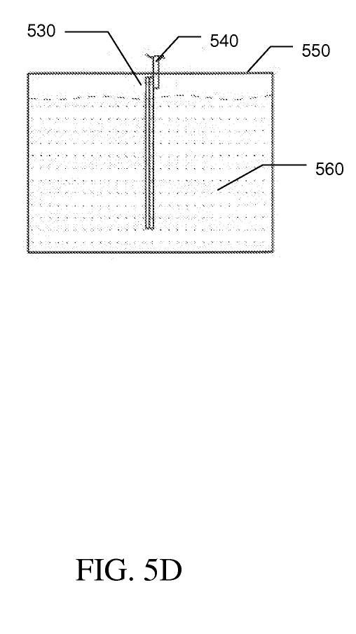

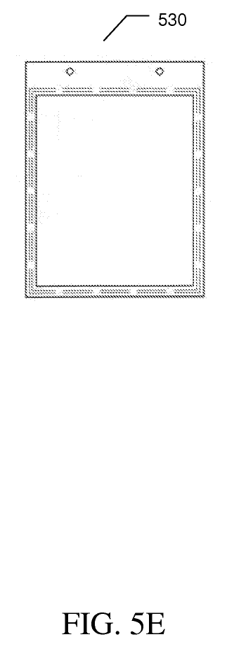

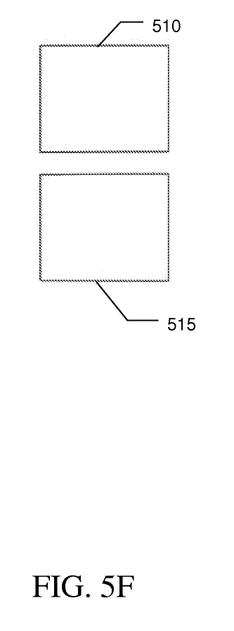

Refer to FIG. 5A, which is a drawing illustrating two objects and an ultrasonic mold prior to treatment according to an embodiment of the present invention.

Prior to treatment, for example a hardness treatment, two similar objects 510, 515 and an ultrasonic mold 520 are prepared. In the embodiment illustrated in FIG. 5A the similar objects 510, 515 are pieces of PMMA material and the ultrasonic mold 520 is a PMMA ultrasonic mold.

Refer to FIG. 5B, which is a drawing illustrating assembly of two objects using an ultrasonic mold according to an embodiment of the present invention and to FIG. 5C, which is a drawing illustrating the assembled two objects using an ultrasonic mold according to an embodiment of the present invention.

To assemble the two pieces of PMMA material 510, 515 the ultrasonic mold 520 is positioned between the two pieces 510, 515 and an ultrasonic process is preformed to hold the two pieces of PMMA material 510, 515 together to form a single sided treatment assembly 530.

Refer to FIG. 5D, which is a drawing illustrating a treatment process on the assembled two objects according to an embodiment of the present invention.

The single sided treatment assembly 530 is attached to a processing arm 540 and lowered into a treatment tank 550 containing treatment solution 560. Since the two objects of the treatment assembly 530 are fixed together only the surfaces exposed to the treatment solution 560 are treated. This allows the present invention to provide an efficient method for treating a single surface of an object.

Refer to FIG. 5E, which is a drawing illustrating the assembled two objects after treatment according to an embodiment of the present invention, and to FIG. 5F, which is a drawing illustrating the two objects after disassembly according to an embodiment of the present invention.

After the treatment assembly 530 is removed from the treatment solution the two objects are separated by laser cutting close to the ultrasonic mold line. The two objects 510, 515 are now separate and are treated on a single side of the object.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A holder for use during a treatment process comprising:
a front wall;
a back wall; and
at least one opening in the front wall or the back wall for securely holding at least one object during the treatment process, the opening being filled when holding the object to form a hollow interior in the holder.

2. The holder for use during a treatment process of claim 1, further comprising:
a grip for attaching to a processing arm during the treatment process.

3. The holder for use during a treatment process of claim 1, where the holder comprises a first piece and a second piece.

4. The holder for use during a treatment process of claim 3, where the first piece and the second piece comprise mating elements allowing the first piece and second piece to attach together to form the holder.

5. The holder for use during a treatment process of claim 3, further comprising:
a first tab on the first piece; and
a second tab on the second piece, the first tab and the second tab allowing the first piece and the second piece to be easily separated.

6. A holder for use during a treatment process comprising:
a first piece;
a second piece, the first piece and the second piece comprising mating elements allowing the first piece and the second piece to attach together;
a first opening in the first piece; and
a second opening in the second piece, the first opening and the second opening for holding objects during the treatment process, the openings being filled when holding the objects to form a hollow interior in the holder.

7. The holder for use during a treatment process of claim 6, further comprising:
a grip for attaching to a processing arm during the treatment process.

8. The holder for use during a treatment process of claim 6, further comprising:
a first tab on the first piece; and
a second tab on the second piece, the first tab and the second tab allowing the first piece and the second piece to be easily separated.

9. A method for treating a single surface of an object comprising:
inserting an object into a holder to form a hollow interior in the holder, the object comprising a first surface and a second surface; and
dipping the holder into a treatment solution, air trapped in the hollow interior preventing the second surface from being exposed to the treatment solution so that only the first surface is treated.

10. The method for treating a single surface of an object of claim 9, further comprising:
removing the holder from the treatment solution.

11. The method for treating a single surface of an object of claim 10, further comprising:
drying the treatment solution on the first surface.

12. The method for treating a single surface of an object of claim 11, further comprising:
removing the object from the holder.

13. The method for treating a single surface of an object of claim 12, further comprising:
creating a groove, notch, design, logo, indentation, or pattern on the second surface of the object.

14. A method for treating a single surface of an object comprising:
inserting an object into a holder to form a hollow interior in the holder, the object comprising a first surface and a second surface;
dipping the holder into a treatment solution, air trapped in the hollow interior preventing the second surface from being exposed to the treatment solution so that only the first surface is treated;
drying the treatment solution on the first surface; and
removing the object from the holder.

15. The method for treating a single surface of an object of claim 14, further comprising:
creating a groove, notch, design, logo, indentation, or pattern on the second surface of the object.

16. A method for treating a single surface of an object comprising:
molding an object with a holder to form a hollow interior in the holder, the object comprising a first surface and a second surface; and
dipping the object with the holder into a treatment solution, air trapped in the hollow interior preventing the second surface from being exposed to the treatment solution so that only the first surface is treated.

17. The method for treating a single surface of an object of claim 16, further comprising:
removing the object with the holder from the treatment solution.

18. The method for treating a single surface of an object of claim 17, further comprising:
drying the treatment solution on the first surface.

19. The method for treating a single surface of an object of claim 18, further comprising:
separating the object from the holder.

20. The method for treating a single surface of an object of claim 19, further comprising:
creating a groove, notch, design, logo, indentation, or pattern on the second surface of the object.

21. A method for treating a single surface of an object comprising:
molding an object with a holder to form a hollow interior in the holder, the object comprising a first surface and a second surface;
dipping the object with the holder into a treatment solution, air trapped in the hollow interior preventing the second surface from being exposed to the treatment solution so that only the first surface is treated;
drying the treatment solution on the first surface; and
separating the object from the holder.

22. The method for treating a single surface of an object of claim 21, further comprising:
creating a groove, notch, design, logo, indentation, or pattern on the second surface of the object.

23. A method for treating a single surface of an object comprising:
molding a first object having a first holder piece;
molding a second object having a second holder piece;
attaching the first holder piece and the second holder piece to form a holder with a hollow interior in the holder, the first object comprising a first surface and a second surface and the second object comprising a third surface and a fourth surface;
dipping the holder into a treatment solution, air trapped in the hollow interior preventing the second surface and the fourth surface from being exposed to the treatment solution so that only the first surface and third surface are treated;
drying the treatment solution on the first surface and third surface; and
separating the first object and second object from the holder.

24. A method for treating a single side of an object comprising:
fixing two similar objects together using an ultrasonic mold to form a treatment assembly;
dipping the treatment assembly into a treatment solution;
drying the treatment solution on the treatment assembly; and
separating the two similar objects.
